(19) United States
(12) Patent Application Publication
(10) Pub. No.: US 2026/0249271 A1
(43) Pub. Date: Aug. 27, 2026

(54) CARBON COMPOSITE MATERIAL PRODUCTS AND METHOD OF MANUFACTURING THE SAME

(71) Applicant: CALGON CARBON CORPORATION, Moon Township, PA (US)

(72) Inventors: Ronghong LIN, Allison Park, PA (US); Richard A. MIMNA, Oakdale, PA (US); Philippe WESTREICH, Pittsburgh, PA (US); Jason P. MAZZOCCOLI, Pittsburgh, PA (US); Steven L. BUTTERWORTH, Moon Township, PA (US); Joseph E. COLE, New Castle, PA (US); Scott J. MUTSCHLER, Poland, OH (US)

(73) Assignee: CALGON CARBON CORPORATION, Moon Township, PA (US)

(21) Appl. No.: 19/548,328

(22) Filed: Feb. 24, 2026

Related U.S. Application Data
(60) Provisional application No. 63/763,123, filed on Feb. 25, 2025.
(60) Provisional application No. 63/943,902, filed on Dec. 18, 2025.

(51) Int. Cl. B01J 20/30; B01D 53/02; B01J 20/20; B01J 20/28; C02F 1/28

(52) U.S. Cl. CPC B01J 20/3042; B01D 53/02; B01J 20/20; B01J 20/28011; B01J 20/2803; B01J 20/28033; B01J 20/3007; C02F 1/283; B01D 2253/102

(57) ABSTRACT

Sorbent material sheet products, methods of manufacturing the sheets, and methods of using the sheets are disclosed herein. The sorbent material sheet products include a sorbent material and binder that is selected to reduce the amount of per- and polyfluoroalkyl substances (PFAS) generated during the binder production. The binders may include binders that do not have fluorine.

### CROSS-REFERENCE TO RELATED APPLICATIONS

This application claims benefit of and priority to U.S. Provisional Patent Application No. 63/763,123 titled “CARBON COMPOSITE MATERIAL PRODUCTS AND METHOD OF MANUFACTURING THE SAME” filed Feb. 25, 2025, and U.S. Provisional Patent Application No. 63/943,902 titled “CARBON COMPOSITE MATERIAL PRODUCTS AND METHOD OF MANUFACTURING THE SAME” filed Dec. 18, 2025, the disclosures of which are incorporated by reference herein in their entireties.

### BACKGROUND

Activated carbon is a versatile material with numerous applications across various industries. Its high surface area and porous structure make it effective for adsorption processes, allowing it to remove contaminants from liquids and gases. In the automotive sector, activated carbon plays a role in controlling evaporative emissions from vehicles, helping to reduce the release of volatile organic compounds into the atmosphere. Water treatment facilities utilize activated carbon to purify drinking water by removing organic compounds, chlorine, and other impurities that can affect taste, odor, and safety. Additionally, activated carbon finds use in gas removal applications, such as air purification and industrial exhaust treatment.

Many activated carbon products are available in powder or granular form, which can present challenges in handling and application. To address these issues, manufacturers often incorporate binders to create more manageable and effective carbon-based materials. One commonly used binder in the production of activated carbon products is polytetrafluoroethylene (PTFE). PTFE offers advantages such as chemical resistance, thermal stability, and low friction, making it suitable for a wide range of applications.

However, recent concerns have emerged regarding the environmental and health impacts of certain fluorinated compounds, including those related to PTFE. These compounds, often referred to as per- and polyfluoroalkyl substances (PFAS), have gained attention due to their persistence in the environment and potential long-term effects on human health and ecosystems. The term “forever chemicals” has been used to describe PFAS, reflecting their resistance to degradation and tendency to accumulate in the environment and living organisms over time.

As awareness of PFAS-related issues grows, there is increasing interest in exploring alternative materials and approaches for binding activated carbon and other adsorbent materials. There exists a need for improved sorbent material sheet products using binders other than PTFE.

### SUMMARY

In one embodiment, a sorbent material sheet product includes a sorbent material and a binder including one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), ethylene vinyl alcohol (EVOH), polyvinylidene chloride (PVDC), and ethylene vinyl acetate (EVA).

In some embodiments, the binder has a particle size of about 1 μm to about 1000 μm.

In some embodiments, the binder has a particle size of about 100 μm to about 800 μm.

In some embodiments, the binder has a particle size of about 500 μm to about 700 μm.

In some embodiments, the sorbent material sheet product has a tensile strength of about 1 N/mm² to about 100 N/mm².

In some embodiments, the sorbent material sheet product has a thickness of about 100 μm to about 5,000 μm.

In some embodiments, the binder is present in the sorbent material sheet product in an amount of about 1 wt. % to about 90 wt. %.

In some embodiments, the binder is present in the sorbent material sheet product in an amount of about 50 wt. %.

In some embodiments, the sorbent material sheet product further includes one or more of carbon black, graphite, carbon nanotubes, copper powder, an ion exchange resin, a polyelectrolyte, and an inorganic nanoparticle.

In some embodiments, the sorbent material includes activated carbon, reactivated carbon, carbon nanotubes, graphenes, natural and synthetic zeolite, silica, silica gel, alumina, zirconia, clay, polymer resins, metal-organic framework (MOF)-based materials, and diatomaceous earths, and combinations thereof.

In one embodiment, a method of manufacturing a sorbent material sheet includes providing a sorbent material and a binder including one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), ethylene vinyl alcohol (EVOH), polyvinylidene chloride (PVDC), and ethylene vinyl acetate (EVA); mixing the sorbent material and the binder to form a mixture; and forming the mixture into a sorbent material sheet.

In some embodiments, the sorbent material sheet is formed by one of molding, slurry coating, extrusion, or rolling.

In some embodiments, the binder has a particle size of about 1 μm to about 1000 μm.

In some embodiments, the binder has a particle size of about 100 μm to about 800 μm.

In some embodiments, the binder has a particle size of about 500 μm to about 700 μm.

In some embodiments, the sorbent material sheet has a tensile strength of about 1 N/mm² to about 100 N/mm².

In some embodiments, the sorbent material sheet is rolled to a thickness of about 100 μm to about 5,000 μm.

In some embodiments, the binder is present in the sorbent material sheet in an amount of about 1 wt. % to about 90 wt. %.

In some embodiments, the binder is present in the sorbent material sheet in an amount of about 50 wt. %.

In some embodiments, the mixture is formed at a temperature of about 25° C. to about 250° C.

In some embodiments, the mixture is formed by rolling using a roll mill, wherein the roll mill is rolled at a rate of about 0.1 ft./min to about 20.0 ft./min.

In some embodiments, the method further includes providing an additive; and adding the additive to the mixture, wherein the additive includes one or more of carbon black, graphite, carbon nanotubes, copper powder, an ion exchange resin, a polyelectrolyte, clay, carbon nanotubes, graphene, metal-organic framework (MOF)-based materials, and an inorganic nanoparticle.

In one embodiment, a method of removing a target compound from a fluid includes providing a sorbent material sheet product including a sorbent material and a binder including one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), ethylene vinyl alcohol (EVOH), polyvinylidene chloride (PVDC), and ethylene vinyl acetate (EVA); and contacting the fluid with the sorbent material sheet product.

### BRIEF DESCRIPTION OF DRAWINGS

FIGS. 1-4 depict flow diagrams of illustrative methods of manufacturing a sorbent material sheet product in accordance with an embodiment.

FIG. 5 depicts a flow diagram of an illustrative method of removing a target compound from a fluid in accordance with an embodiment.

FIGS. 6A-8C depict sorbent material sheets in accordance with an embodiment.

FIGS. 9A-10B depict graphical representations of testing performed on sorbent material sheets in accordance with an embodiment.

FIG. 11 depicts sorbent material sheets in accordance with an embodiment.

FIGS. 12A-12C depict graphical representations of testing performed on sorbent material sheets in accordance with an embodiment.

FIG. 13 depicts sorbent material sheets in accordance with an embodiment.

FIGS. 14A-14E depict graphical representations of testing performed on powder binders in accordance with an embodiment.

### Definitions

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

As used herein, the term “fresh sorbent media” means a sorbent material that contains sorbent capacity. For example, a fresh sorbent media may comprise a virgin activated carbon.

As used herein, the term “spent sorbent media” means a sorbent material that has used all or essentially all of its sorbent capacity.

As used herein, the term “sorbent material” is meant to encompass all known materials from any source that are capable of absorbing or adsorbing liquids and/or gases. For example, sorbent materials include, but are not limited to, activated carbon, reactivated carbon, natural and synthetic zeolite, silica, silica gel, alumina, zirconia, clay, polymer resins, carbon nanotubes, graphene, metal-organic framework (MOF)-based materials, and diatomaceous earths.

As used herein, the term “perfluoroalkyl and polyfluoroalkyl substances (PFAS)” means any perfluoroalkyl or polyfluoroalkyl substance, mixture of such substances, or derivative of one or more such substances. Examples of PFAS include perfluoroalkyl sulfonate, perfluoroalkane sulfonic acid (PFSA), N-Butyl perfluoroalkane sulfonamide (BuFASA), N-Butyl perfluoroalkane sulfonamido ethanols (BuFASE), N-Butyl perfluoroalkane sulfonamido acetic acid (BuFASAA), N-Ethyl perfluoroalkane sulfonamide (EtFASA), N-Ethyl perfluoroalkane sulfonamido ethanol (EtFASE), N-Ethyl perfluoroalkane sulfonamido acetic acid (EtFASAA), perfluoroalkane sulfonamide (FASA), perfluoroalkane sulfonamido ethanol (FASE), perfluoroalkane sulfonamido acetic acid (FASAA), N-Methyl perfluoroalkane sulfonamide (MeFASA), N-Methyl perfluoroalkane sulfonamido acetic acid (MeFASAA), N-Methyl perfluoroalkane sulfonamido ethanol (MeFASE), N-Methyl perfluorooctane sulfonamide (MeFOSA), perfluoroalkane sulfonyl fluoride (PASF), 4,8-dioxa-3H-perfluorononanoate, ammonium perfluorooctanoate (APFO), fluoroprotein (FP), fluorotelomer carboxylic acid (FTCA), fluorotelomer alcohol (FTOH), fluorotelomer sulfonate (FTS), fluorotelomer sulfonic acid (FTSA), perfluoroalkyl acid (PFAA), perfluoroalkylsulfonamidoethanol (PFOSE), and any derivatives thereof. These derivatives include, for example and without limitation, perfluorooctanoic acid (PFOA), perfluorooctane sulfonate, perfluorooctanesulfonic acid (PFOS), 2,3,3,3,-tetrafluoro-2-(heptafluoropropoxy) propanoate, ammonium 2,3,3,3-tetrafluoro-2-(heptafluoropropoxy) propanoate (GenX), 1,2,2,2-tetrafluoroethyl ether, 4:2-fluorotelomersulfonic acid (4:2 FtS), 6:2-fluorotelomersulfonic acid (6:2 FtS), 8:2-fluorotelomersulfonic acid (8:2 FtS), perfluorobutanoic acid (PFBA), perfluorobutane sulfonate, perfluorobutane sulfonic acid (PFBS), perfluorohexane sulfonate, perfluorohexane sulfonic acid (PFHxS), perfluorohexanoate, perfluorohexanoic acid (PFHxA), 4,8-dioxa-3H-perfluorononanoate, ammonium perfluorooctanoate (APFO), N-Ethyl perfluorooctane sulfonamide (EtFOSA), N-Ethyl perfluorooctane sulfonamido ethanol (EtFOSE), perfluorooctane sulfonamide (PFOSA), perfluorooctane sulfonamido acetic acid (FOSAA), perfluorooctane sulfonamido ethanol (FOSE), perfluorobutanoate, perfluorobutanoic acid, perfluorobutyrate, perfluorobutyric acid, perfluoroalkyl carboxylate, perfluoroalkyl carboxylic acid (PFCA), perfluorodecanoate, perfluorodecanoic acid (PFDA), perfluorododecanoate, perfluorododecanoic acid (PFDoA), perfluorododecane sulfonate (PFDOS), perfluorododecane sulfonic acid (PFDoSA), perfluorodecane sulfonate, perfluorodecane sulfonic acid (PFDS), perfluoroheptanoate, perfluoroheptanoic acid (PFHpA), perfluoroheptane sulfonate, perfluoroheptane sulfonic acid (PFHpS), perfluorononanoate, perfluorononanoic acid (PFNA), perfluorononane sulfonate, perfluorononane sulfonic acid (PFNS), perfluorooctanoate, perfluorophosphonic acid (PFPA), perfluoropentanoate, perfluoropentanoic acid (PFPeA), perfluoropentane sulfonate, perfluoropentane sulfonic acid (PFPeS), perfluorophosphinic acid (PFPiA), perfluorotetradecanoic acid (PFTeDA), perfluorotridecanoic acid (PFTrDA), perfluoroundecanoate, perfluoroundecanoic acid (PFUnA), perfluoroundecane sulfonate (PFUnS), perfluoroundecane sulfonic acid (PFUnSA), or polytetrafluoroethylene (PTFE).

The scope of the present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

### DETAILED DESCRIPTION

This disclosure is not limited to the particular systems, devices, and methods described, as these may vary. The terminology used in the description is for the purpose of describing the particular versions or embodiments only and is not intended to limit the scope.

### Products

In some embodiments, a sorbent material sheet product is prepared for the removal of target compounds from a fluid. The sorbent material sheet product may comprise a sorbent material and a binder. The binder may be selected to reduce or eliminate the generation of per- and polyfluoroalkyl substances during the binder production. In some embodiments, the binder is fluorine-free. In some embodiments, the binder comprises one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), polyvinylidene chloride (PVDC), ethylene vinyl acetate (EVA), high density polyethylene (HDPE), polyamide 12 (PA12), perfluoroalkoxy (PFA), fluorinated ethylene propylene (FEP), ethylene acrylate, methyl acrylate, ethylene chlorotrifluoroethylene (ECTFE), polypropylene (PP), ethylene vinyl alcohol (EVOH), polyphenylene ether (PPE), acrylonitrile styrene acrylate (ASA), cellulose acetate butyrate (CAB), cellulose proprionate (CP), polyetheretherketone (PEEK), polyethylene terephthalate (PET), polycarbonate (PC), polyphenylene sulfone (PPSU), cellulose diacetate, chlorinated polyvinyl chloride (CPVC), polymethylpentene (PMP), cellulose acetate (CA), polyglycolides (PGA), polyoxymethylene (POM), transparent acrylonitrile butadiene styrene (MABS), polyamide 46 (PA46), polyamides, acrylonitrile butadiene styrene (ABS), polystyrene (PS), high impact polystyrene (HIPS), polyethersulfone (PESU), crosslinked polyethylene, polymethylpentene, (PMP), polyamideimide (PAI), polyethylenimine (PEI), self reinforced polyphenylene (SRP), polybutylene terephthalate (PBT), poly(3-hydroxybutyrate-co-3-hydroxyvalerate) (PHBV), polylactide (PLA), polymethyl methacrylate (PMMA), polyamide 11 (PA11), polyamide 66 (PA66), polyacrylonitrile (PAN), polyhydroxybutyrate (PHB), polyphthalamide (PPA), styrene methyl methacrylate (SMMA), liquid crystal polymer, polysulfone (PSU), styrene acrylonitrile (SAN), styrene maleic anhydride (SMA), polyacrylamide (PARA), cyclic olefin copolymer (COC), polyphenylene sulfide (PPS), other polymers, and copolymers thereof. The sorbent material sheet products may also have improved properties as compared to traditional sorbent material sheet products comprising PTFE as a binder including improved tensile strength, adsorption performance, flexibility, and density.

The sorbent material sheet product may comprise any sorbent material known to one of skill in the art. In some embodiments, the sorbent material comprises one of activated carbon, reactivated carbon, carbon nanotubes, graphenes, natural and synthetic zeolite, silica, silica gel, alumina, zirconia, clay, MOF based materials, polymer resins, and diatomaceous earths, and combinations thereof. In some embodiments, the sorbent material is prepared from bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, polymer fibers, and/or any other carbonaceous material or combinations thereof.

In some embodiments, the activated carbon may be of various grades and types selected based on performance requirements, cost, and other considerations. In some embodiments, the activated carbon may be granular from reagglomerating a powder, granular from crushing or sizing nutshells, wood, coal or pellets created by extrusion, or activated carbon in powdered form. The activated carbon may be formed by processes of carbonization and activated. In some embodiments, the raw material, such as wood, nutshell, coal, pitch, etc. is oxidized and devolatized, with steam and/or carbon dioxide gasified to form the pore structure in the activated carbon which is useful for adsorption. In some embodiments, the initial oxidation and devolatilization process may include a chemical treatment with a dehydrating chemical, such as phosphoric acid, sulfuric acid, sodium hydroxide, potassium hydroxide, zinc chloride, iron (III) chloride, and combinations of those.

A variety of activation processes are known in the art. In some embodiments, the most processes for providing activated carbon for the sorbent material sheets of the claimed invention involve a step of providing wood and/or wood byproduct, acid treating the wood and/or wood byproducts by exposure to phosphoric acid, and carbonizing the wood and/or wood byproducts using steam and/or carbon dioxide gasification. This process results in activated carbon particles having a high butane working capacity (“BWC”), which is a measure of activated carbon performance.

In some embodiments, the activated carbon may be formed from materials including bagasse, bamboo, coconut husks, peat, wood such as hardwood and softwood sources in the form of sawdust and scrap, lignite, coal and coal tar, petroleum pitch, asphalt and bitumen, corn stalks and husks, wheat straw, spent grains, rice hulls and husks, nutshells, lignin, and combinations thereof.

In some embodiments, the sorbent material is a powder. In some embodiments, the sorbent material may be made by pulverizing granular or pelletized sorbent material to a powder. The powder may have any average particle size effective for the adsorption of a target compound and for forming a sheet. In some embodiments, the powder size may be controlled using one or more mesh sizes. In some embodiments, the powder has an average particle size of less than about 1 μm, about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 150 μm, about 200 μm, about 250 μm, about 300 μm, about 350 μm, about 400 μm, about 450 μm, about 500 μm, or any value or range of values between any two of these values.

The sorbent material sheet product may comprise any binder effective for holding the sorbent material together in a sheet. In some embodiments, the binder comprises one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), ethylene vinyl alcohol (EVOH), polyvinylidene chloride (PVDC), and ethylene vinyl acetate (EVA). The binder may be selected to optimize one or more of the flexibility, tensile strength, thickness, adsorptive properties, and density of the sorbent material sheet product.

The binder may comprise any particle size effective for use in a sorbent material sheet product. The selection of the binder particle size is critical in the sheet forming ability of the sorbent material and the binder. The binder size may be selected to optimize sorbent material sheet formation. In some embodiments, the binder particle size may be controlled using one or more mesh sizes. In some embodiments, the binder has a particle size of less than 1 μm, about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1000 μm, or any value or range of values between any two of these values. In some embodiments, the binder has a particle size of about 1 μm to about 1000 μm, about 100 μm to about 800 μm, or about 500 μm to about 700 μm. In some embodiments, the binder may be present in a bimodal particle size distribution.

The binder may be present in the sorbent material sheet product in any amount effective for the formation of a sheet. The binder content may be selected to optimize sorbent material sheet formation. In some embodiments, the binder is present in the sorbent material sheet product in an amount of about 1 wt. %, about 2 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, about 95 wt. %, or any value or range of values between any two of these values. In some embodiments, the binder is present in the sorbent material sheet product in an amount of about 1 wt. % to about 90 wt. %. In some embodiments, the binder is present in the sorbent material sheet product in an amount of about 30 wt. % to about 70 wt. %.

The flexibility, tensile strength, thickness, and density of the sheet product may be optimized for specific applications. For instance, a more flexible sheet with lower density may be suitable for certain filtration applications, while a more rigid sheet may be preferred for other uses. These parameters may be optimized using one or more of a binder selection, a binder content, a binder particle size, a temperature at which the sheet is manufactured, and a roll speed during manufacturing. It was determined that flexibility of the sheet product may be controlled by the binder selection.

The sorbent material sheet product may have any tensile strength effective for the adsorption of a target compound. In some embodiments, the sorbent material sheet product may have a tensile strength of about 0.01 N/mm², about 0.05 N/mm², about 0.1 N/mm², about 0.2 N/mm², about 0.3 N/mm², about 0.4 N/mm², about 0.5 N/mm², about 0.6 N/mm², about 0.7 N/mm², about 0.8 N/mm², about 0.9 N/mm², about 1.0 N/mm², about 1.5 N/mm², about 2.0 N/mm², about 2.5 N/mm², about 3.0 N/mm², about 3.5 N/mm², about 4.0 N/mm², about 4.5 N/mm², about 5.0 N/mm², about 5.5 N/mm², about 6.0 N/mm², about 6.5 N/mm², about 7.0 N/mm², about 7.5 N/mm², about 8.0 N/mm², about 8.5 N/mm², about 9.0 N/mm², about 9.5 N/mm², about 10 N/mm², about 20 N/mm², about 30 N/mm², about 40 N/mm², about 50 N/mm², about 60 N/mm², about 70 N/mm², about 80 N/mm², about 90 N/mm², about 100 N/mm², about 150 N/mm², about 200 N/mm², about 250 N/mm², about 300 N/mm², about 350 N/mm², about 400 N/mm², about 450 N/mm², about 500 N/mm², or any value or range of values between any two of these values. In some embodiments, the sorbent material sheet product has a tensile strength of about 1 N/mm² to about 10 N/mm². In some embodiments, the sorbent material sheet product has a tensile strength of about 10 N/mm² to about 100 N/mm².

The sorbent material sheet product may have any thickness effective for the adsorption of a target compound. In some embodiments, the thickness is selected based on a desired density of the sorbent material sheet product, as a thinner sheet results in a denser sheet. In some embodiments, the sorbent material sheet product has a thickness of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1000 μm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm, about 4.0 mm, about 5.0 mm, or any value or range of values between any two of these values. In some embodiments, the sorbent material sheet product has a thickness of about 100 μm to about 5.0 mm or about 100 μm to about 3 mm. In some embodiments, the sorbent material sheet product has a density of about 0.1 g/m, about 0.2 g/m, about 0.3 g/m, about 0.4 g/m, about 0.5 g/m, about 0.6 g/m, about 0.7 g/m, about 0.8 g/m, about 0.9 g/m, about 1.0 g/m, about 1.1 g/m, about 1.2 g/m, about 1.3 g/m, about 1.4 g/m, about 1.5 g/m, about 1.6 g/m, about 1.7 g/m, about 1.8 g/m, about 1.9 g/m, about 2.0 g/m, or any value or range of values between any two of these values.

In some embodiments, the sorbent material sheet product may further comprise an additive. In some embodiments, the additive may be configured to increase one or more of the electrical conductivity, thermal conductivity, electromagnetic shielding, or radar absorption of the sorbent material sheet. In some embodiments, the additive comprises one or more of carbon black, graphite, carbon nanotubes, copper powder, an ion exchange resin, a polyelectrolyte, a MOF material, and an inorganic nanoparticle. The additive may be present in the sorbent material sheet product in any amount. In some embodiments, the additive is present in the sorbent material sheet product in an amount of about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.5 wt. about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 30 wt. %, about 35 wt. %, about 40 wt. %, about 45 wt. %, about 50 wt. %, about 60 wt. %, about 70 wt. %, about 80 wt. %, about 90 wt. %, or any value or range of values between any two of these values.

### Methods of Manufacturing

Methods may be performed to manufacture the sorbent material sheets as described above.

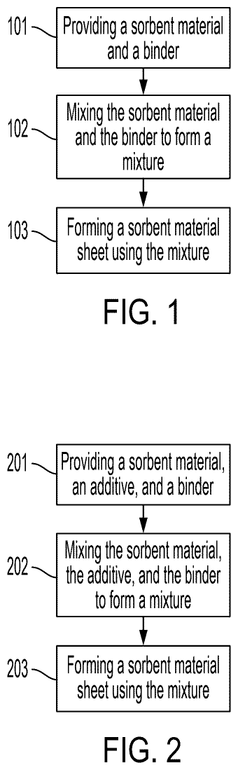

FIG. 1 depicts a flow diagram of a method of manufacturing a sorbent material sheet. The method comprises providing 101 a sorbent material and a binder. In some embodiments, the sorbent material comprises activated carbon, reactivated carbon, carbon nanotubes, graphenes, natural and synthetic zeolite, silica, silica gel, alumina, zirconia, clay, polymer resins, metal-organic framework (MOF)-based materials, and diatomaceous earths, and combinations thereof. In some embodiments, the binder comprises comprising one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), ethylene vinyl alcohol (EVOH), polyvinylidene chloride (PVDC), and ethylene vinyl acetate (EVA).

The binder may be provided 101 in any amount effective for the formation of a sheet. The binder content may be selected to optimize sorbent material sheet formation. In some embodiments, the binder is provided 101 in an amount as compared to the total weight of the sorbent material sheet product of about 1 wt. %, about 2 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, about 95 wt. %, or any value or range of values between any two of these values. In some embodiments, the binder is present in the sorbent material sheet product in an amount of about 1 wt. % to about 90 wt. %. In some embodiments, the binder is present in the sorbent material sheet product in an amount of about 30 wt. % to about 70 wt. %.

The method may further comprise mixing 102 the sorbent material and the binder to form a mixture. The sorbent material and the binder may be mixed 102 until the mixture is homogenous. The sorbent material and the binder may be mixed at any temperature effective for the production of a sorbent material sheet. In some embodiments, the mixing temperature may be selected based on one of the melting point or the softening points of the binder. In some embodiments, the sorbent material and the binder are mixed at a temperature of about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., about 200° C., about 205° C., about 210° C., about 215° C., about 220° C., about 225° C., about 230° C., about 235° C., about 240° C., about 245° C., about 250° C., or any value or range of values between any two of these values.

The method may further comprise forming 103 a sorbent material sheet using the mixture. The sorbent material sheet may be formed 103 by any process of making a sheet known to one of ordinary skill in the art. In some embodiments, the sorbent material sheet is formed 103 by one of molding, slurry coating, extrusion, or rolling. In some embodiments, the mixture is rolled using a roll mill. The mixture may be formed 103 at any temperature effective for the production of a sorbent material sheet. In some embodiments, the temperature of the roller may be selected based on one of the melting point or the softening points of the binder. In some embodiments, the mixture is formed 103 at a temperature of about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 120° C., about 130° C., about 140° C., about 150° C., about 160° C., about 170° C., about 180° C., about 190° C., about 200° C., about 205° C., about 210° C., about 215° C., about 220° C., about 225° C., about 230° C., about 235° C., about 240° C., about 245° C., about 250° C., or any value or range of values between any two of these values. In some embodiments, the mixture is formed 103 at a temperature of about 50° C. to about 200° C.

The mixture may be rolled at any roll speed effective for the production of a sorbent material sheet. In some embodiments, the mixture is rolled at a rate of about 0.1 ft./min, about 0.2 ft./min, about 0.3 ft./min, about 0.4 ft./min, about 0.5 ft./min, about 0.6 ft./min, about 0.7 ft./min, about 0.8 ft./min, about 0.9 ft./min, about 1.0 ft./min, about 1.1 ft./min, about 1.2 ft./min, about 1.3 ft./min, about 1.4 ft./min, about 1.5 ft./min, about 1.6 ft./min, about 1.7 ft./min, about 1.8 ft./min, about 1.9 ft./min, about 2.0 ft./min, about 2.1 ft./min, about 2.2 ft./min, about 2.3 ft./min, about 2.4 ft./min, about 2.5 ft./min, about 2.6 ft./min, about 2.7 ft./min, about 2.8 ft./min, about 2.9 ft./min, about 3.0 ft./min, about 3.1 ft./min, about 3.2 ft./min, about 3.3 ft./min, about 3.4 ft./min, about 3.5 ft./min, about 3.6 ft./min, about 3.7 ft./min, about 3.8 ft./min, about 3.9 ft./min, about 4.0 ft./min, about 4.1 ft./min, about 4.2 ft./min, about 4.3 ft./min, about 4.4 ft./min, about 4.5 ft./min, about 4.6 ft./min, about 4.7 ft./min, about 4.8 ft./min, about 4.9 ft./min, about 5.0 ft./min, about 5.1 ft./min, about 5.2 ft./min, about 5.3 ft./min, about 5.4 ft./min, about 5.5 ft./min, about 5.6 ft./min, about 5.7 ft./min, about 5.8 ft./min, about 5.9 ft./min, about 6.0 ft./min, about 6.1 ft./min, about 6.2 ft./min, about 6.3 ft./min, about 6.4 ft./min, about 6.5 ft./min, about 6.6 ft./min, about 6.7 ft./min, about 6.8 ft./min, about 6.9 ft./min, about 7.0 ft./min, about 7.1 ft./min, about 7.2 ft./min, about 7.3 ft./min, about 7.4 ft./min, about 7.5 ft./min, about 7.6 ft./min, about 7.7 ft./min, about 7.8 ft./min, about 7.9 ft./min, about 8.0 ft./min, about 8.1 ft./min, about 8.2 ft./min, about 8.3 ft./min, about 8.4 ft./min, about 8.5 ft./min, about 8.6 ft./min, about 8.7 ft./min, about 8.8 ft./min, about 8.9 ft./min, about 9.0 ft./min, about 9.1 ft./min, about 9.2 ft./min, about 9.3 ft./min, about 9.4 ft./min, about 9.5 ft./min, about 9.6 ft./min, about 9.7 ft./min, about 9.8 ft./min, about 9.9 ft./min, about 10.0 ft./min, about 10.5 ft./min, about 11.0 ft./min, about 11.5 ft./min, about 12.0 ft./min, about 12.5 ft./min, about 13.0 ft./min, about 13.5 ft./min, about 14.0 ft./min, about 14.5 ft./min, about 15.0 ft./min, about 15.5 ft./min, about 16.0 ft./min, about 16.5 ft./min, about 17.0 ft./min, about 17.5 ft./min, about 18.0 ft./min, about 18.5 ft./min, about 19.0 ft./min, about 19.5 ft./min, about 20.0 ft./min, or any value or range of values between any two of these values.

The thickness of the sorbent material sheet may be controlled by the distance between two rolls of a roll mill. In some embodiments, the thickness is selected based on a desired density of the sorbent material sheet product. For example, a thicker sheet may result in a denser sheet. In some embodiments, the mixture is rolled to a thickness of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1000 μm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm, about 4.0 mm, about 5.0 mm, or any value or range of values between any two of these values, or any value or range of values between any two of these values.

In some embodiments, the method may further comprise providing an additive and adding the additive to the mixture. FIG. 2 depicts a flow diagram of a method of manufacturing a sorbent material sheet comprising a sorbent material, an additive, and a binder. The method may comprise providing 201 a sorbent material, an additive, and a binder, mixing 202 the sorbent material, the additive, and the binder to form a mixture, and forming 203 a sorbent material sheet using the mixture. In some embodiments, the additive may comprise one or more of carbon black, graphite, carbon nanotubes, copper powder, an ion exchange resin, a polyelectrolyte, a MOF material, and an inorganic nanoparticle. The additive content may be selected to optimize sorbent material sheet formation. In some embodiments, additive is provided in an amount as compared to the total weight of the sorbent material sheet product of about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.5 wt. about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 30 wt. %, about 35 wt. %, about 40 wt. %, about 45 wt. %, about 50 wt. %, about 60 wt. %, about 70 wt. %, about 80 wt. %, about 90 wt. %, or any value or range of values between any two of these values.

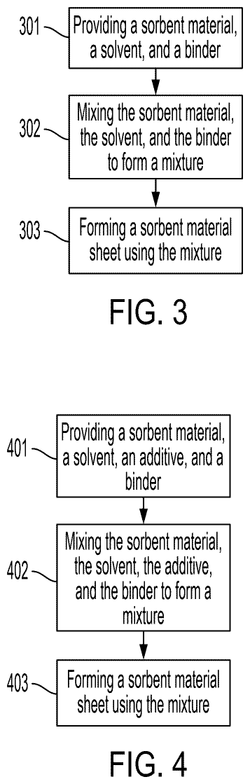

In some embodiments, the method may further comprise providing a solvent and forming a solution by combining the solvent and the mixture. FIG. 3 depicts a flow diagram of a method of manufacturing a sorbent material sheet comprising a sorbent material, a solvent, and a binder. The method may comprise providing 301 a sorbent material, a solvent, and a binder, mixing 302 the sorbent material, the solvent, and the binder to form a mixture, and forming 303 a sorbent material sheet using the mixture. FIG. 4 depicts a flow diagram of a method of manufacturing a sorbent material sheet comprising a sorbent material, a solvent, an additive, and a binder. The method may comprise providing 401 a sorbent material, a solvent, an additive, and a binder, mixing 402 the sorbent material, the solvent, the additive, and the binder to form a mixture, and forming 403 a sorbent material sheet using the mixture. The use of a solvent may be selected based on the selected binder and the desired properties of the sorbent material sheet. In some embodiments, the solvent comprises one or more of 1-methyl-2-pyrrolidinone (NMP), dimethylacetamide (DMAc), water, ethanol, isopropanol, dimethylforamide (DMF), or dimethyl sulfoxide (DMSO). In such an embodiment, the method may further comprise drying the sorbent material sheet after the sorbent material sheet is rolled. The sorbent material sheet may be dried at any temperature effective for removing the solvent from the sorbent material sheet. In some embodiments, the drying temperature may be selected to control the butane working capacity (BWC) of the sorbent material sheet. In some embodiments, the sorbent material sheet is dried at a temperature of about 50° C., about 55° C., about 60° C., about 65° C., about 70° C., about 75° C., about 80° C., about 85° C., about 90° C., about 95° C., about 100° C., about 105° C., about 110° C., about 120° C., about 130° C., about 140° C., about 150° C., about 160° C., about 170° C., about 180° C., about 190° C., about 200° C., or any value or range of values between any two of these values.

### Methods of Use

Methods may be performed to remove target compounds from fluids using the above-described sorbent material sheets.

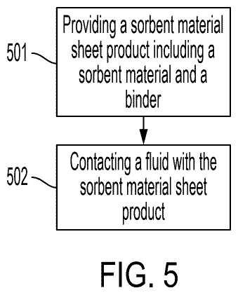

FIG. 5 depicts a flow diagram of a method of removing a target compound from a fluid. The method comprises providing 501 a sorbent material sheet product comprising sorbent material and a binder. In some embodiments, the sorbent material comprises activated carbon, reactivated carbon, carbon nanotubes, graphenes, natural and synthetic zeolite, silica, silica gel, alumina, zirconia, and diatomaceous earths, and combinations thereof. In some embodiments, the binder comprises comprising one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), ethylene vinyl alcohol (EVOH), polyvinylidene chloride (PVDC), and ethylene vinyl acetate (EVA).

In some embodiments, the sorbent material sheet product may further comprise an additive. In some embodiments, the additive may be configured to increase one or more of the electrical conductivity, thermal conductivity, electromagnetic shielding, or radar absorption of the sorbent material sheet. In some embodiments, the additive comprises one or more of carbon black, graphite, carbon nanotubes, copper powder, an ion exchange resin, a polyelectrolyte, a MOF material, and an inorganic nanoparticle.

The method may further comprise contacting 502 the fluid with the sorbent material sheet product. This allows the sorbent material sheet product to adsorb the target compound and remove the compound from the fluid. In some embodiments, the target compound is an organic compound. The sorbent material product may be used in the purification of drinking water. In some embodiments, the sorbent material sheet product may adsorb contaminants such as PFAS, chlorine, volatile organic compounds (VOCs), pesticides, herbicides, and heavy metals from water.

In some embodiments, the sorbent material sheet product may be utilized in portable or small-scale filtration systems for food and beverage applications. The sheet product may be incorporated into compact filter designs that can be easily transported or integrated into small appliances, providing effective removal of contaminants from water or other liquids. In some embodiments, the sorbent material sheet product may be used in applications in larger-scale water treatment processes. In some embodiments, it may be employed as a contaminant removal step in municipal water treatment systems, helping to further refine the quality of treated effluent before release. This additional filtration stage may help remove trace contaminants or improve the overall purity of the treated water.

In residential water treatment applications, the sorbent material sheet product may be incorporated into point-of-entry or whole-house filtration systems. These systems may be installed at the main water line entering a home, providing comprehensive water treatment for all household uses. The sheet product may serve as a key component in such systems, offering efficient removal of a wide range of contaminants. The sorbent material sheet product may also be utilized in point-of-use applications, such as under-sink or countertop water filtration units. In these configurations, the sheet product may provide targeted treatment for drinking water.

In some embodiments, the sorbent material sheet product may be used in an automotive use in an onboard refueling vapor recovery system. In addition to automotive uses, the inventors contemplate that the sorbent sheets of the claimed invention can be used in any instance where a tank or other enclosed space is designed to contain volatile liquids, in particular volatile hydrocarbons such as fuels, solvents, and other volatile compounds. Examples include but are not limited to fuel tanks in aircraft, fuel tanks in ships and other marine vehicles, fuel tanks in trucks, chemical tanks in railroad cars, barges, ships, trucks, vehicles, and other bulk carriers, and stationary chemical tanks.

In some embodiments, the sorbent material sheet product may be utilized in military applications. The sheets may be incorporated into structures such as tents, operating theaters, and command posts. In such an embodiment, the sorbent material sheet product may provide additional functionalities beyond contaminant removal. For instance, the sheets may be configured to provide radar absorption capabilities, potentially reducing the radar cross-section of military installations. Additionally, the sorbent material sheet product may be configured to provide electromagnetic shielding, which may help protect sensitive electronic equipment from interference or detection. These properties may enhance the overall effectiveness and security of military operations in various environments.

### EXAMPLES

### Example 1: Production of Sorbent Material Sheets Using Polyethylene

Sorbent material sheet products were prepared using activated carbon as a sorbent material and polyethylene as a binder. Various sheets were formed using different sized polyethylene particles. Each of the sorbent material sheets was manufactured by mixing 50 wt. % RB activated carbon from Calgon Carbon Corporation and 50 wt. % polyethylene and rolling a sheet using a roll mill. The sheets were made using polyethylene with particles sizes of 20 μm, 38 μm, 55 μm, 135 μm, and 145 μm. The sorbent material sheet using polyethylene with a particle size of 38 μm was formed using a roller with a temperature of about 110° C. and a roller with a temperature of about 134° C. The sorbent material sheet using polyethylene with a particle size of 55 μm was formed using a roller with a temperature of about 115° C. and a roller with a temperature of about 125° C. The sorbent material sheet using polyethylene with a particle size of 135 μm was formed using a roller with a temperature of about 120° C. to about 135° C. and a roller with a temperature of about 110° C. to about 115° C. The sorbent material sheet using polyethylene with a particle size of 145 μm was formed using a roller with a temperature of about 110° C. and a roller with a temperature of about 115° C. The sorbent material sheet using polyethylene with a particle size of 20 μm was formed using a roller with a temperature of about 105° C. to about 110° C. and a roller with a temperature of about 100° C. to about 105° C. As the particle size increased, the quality of the sheets formed decreased as only the sheet made using polyethylene of 20 μm showed high sheetability. These results show the importance of the particle size on the quality of the sorbent material sheets that are formed.

### Example 2: Production of Sorbent Material Sheets Using Alternative Binders

Sorbent material sheets were produced using 50 wt. % RB activated carbon from Calgon Carbon Corporation and 50 wt. % of a binder. Each of the sheets was made by blending a mixture of the carbon and binder at room temperature for three minutes. Each of the mixtures was then rolled into a sheet using a roll mill at a temperature of about 60° C. to about 71° C., a roll speed of 3.1 ft./min, and a sheet thickness of about 0.3-0.5 mm. Each mixture was allowed to sit on the roll for 5 minutes before rolling to adjust the temperature of the mixture. The samples were prepared using the following binders: (1) wet drying lines course screeners PVB, (2) dry drying lines course screeners PVB, (3) dry drying line centrifuge fines PVB, (4) a composite PVB, (5) PVC powder, (6) LDPE powder with a particle size of 500 μm, (7) PVDF powder with a particle size of 125-250 μm, (8) LDPE powder screened using a 30 US mesh, and (9) PVDF powder screened using a 30 US mesh. The only samples to successfully produce a sorbent material sheet were samples 7 and 8. Sample 7 produced a rigid sheet, while sample 8 produced a flexible sheet. Sheets were cut from sample 8 and used for tensile strength testing. The results of the testing showed a tensile strength in the machine direction of 1.00 N/mm² and a tensile strength in the cross direction of 0.90 N/mm².

### Example 3: Production of Sorbent Material Sheets Using PCL and LDPE

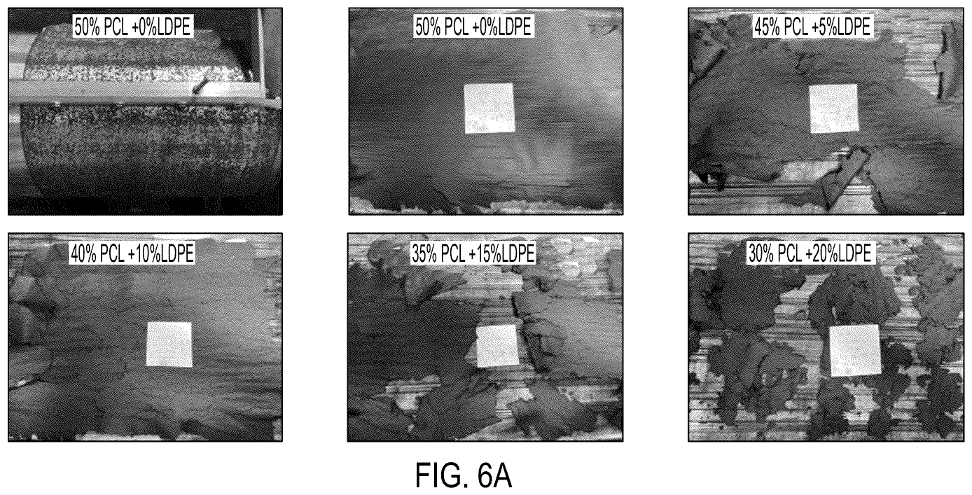

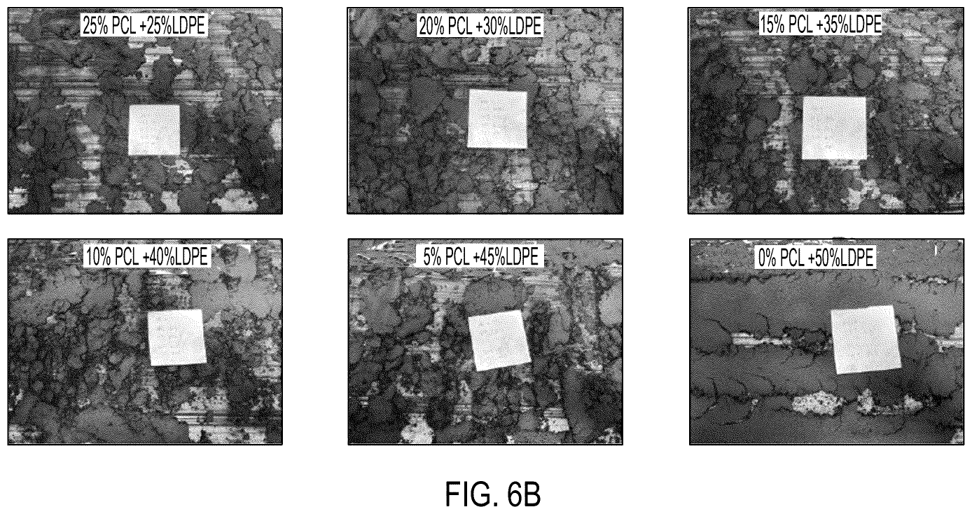

Sorbent material sheets were produced using 50 wt. % RB activated carbon from Calgon Carbon Corporation and various loading of PCL and LDPE. Each of the sheets was made by blending a mixture of the carbon and binder at room temperature and then rolling into a sheet using a roll mill with a surface temperature of about 77° C. The binder loadings were as follows: (1) 50 wt. % PCL, (2), 45 wt. % PCL and 5 wt. % LDPE, (3) 40 wt. % PCL and 10 wt. % LDPE, (4) 35 wt. % PCL and 15 wt. % LDPE, (5) 30 wt. % PCL and 20 wt. % LDPE, (6) 25 wt. % PCL and 25 wt. % LDPE, (7) 20 wt. % PCL and 30 wt. % LDPE, (8) 15 wt. % PCL and 35 wt. % LDPE, (9) 10 wt. % PCL and 40 wt. % LDPE, (10) 5 wt. % PCL and 45 wt. % LDPE, and (11) 50 wt. % LDPE. Images of the sheets are provided in FIG. 6A and 6B. The results show that the mixture of PCL and LDPE were able to provide viable sheets at the operating temperatures, with samples 1, 2, 3, and 11 providing the highest quality sheets.

### Example 4: Production of Sorbent Material Sheets Using TPU

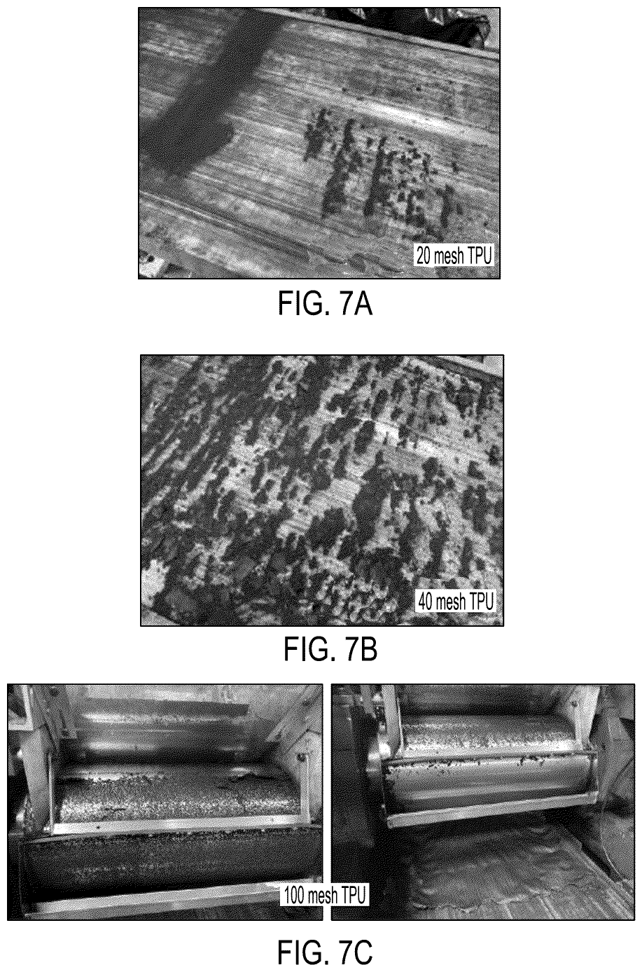

Sorbent material sheets were produced using RB activated carbon from Calgon Carbon Corporation and TPU with various particle sizes. Each of the sheets was made by blending a mixture of the carbon and binder at room temperature and then rolling into a sheet using a roll mill with a surface temperature of about 77° C. at a rate of about 1.3 to 4.26 ft/min. The samples were prepared as follows: (1) 400 g RB activated carbon and 375 g TPU filtered using a 20 US mesh, (2) 400 g RB activated carbon and 376 g TPU filtered using a 40 US mesh, and (3) 300 g RB activated carbon and 281.5 g TPU filtered using a 100 US mesh. Images of the sheets are provided in FIGS. 7A-7C. The results show that only sample 3 was able to provide a viable sheet at the operating temperature of the roll mill. This shows the importance of the binder particle size on the sheetability of the mixtures.

### Example 5: Production of Sorbent Material Sheets Using TPU

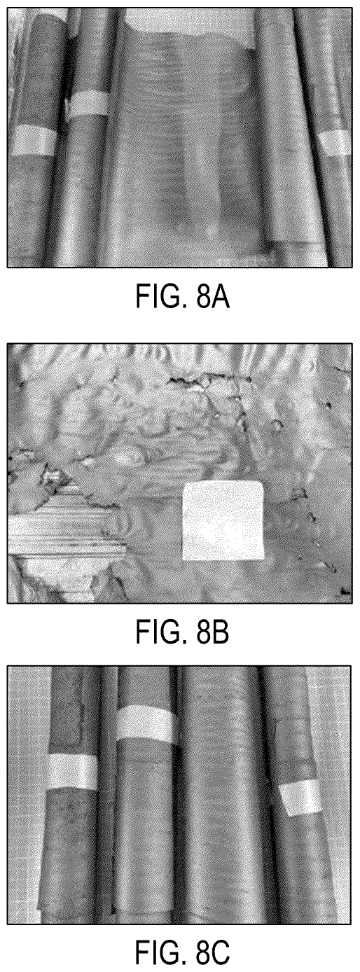

Sorbent material sheets were produced using YP50 activated carbon from Calgon Carbon Corporation, carbon black, and TPU with various particle sizes. Each of the sheets was made by blending a mixture of the carbon, the carbon black, and binder at room temperature and then rolling into a sheet using a roll mill with a surface temperature of about 77° C. at a rate of about 1.3 ft/min. The samples were prepared as follows: (1) 44 wt. % YP50 carbon, 6 wt. % carbon black, and 50 wt. % TPU filtered using a 100 US mesh, (2) 44 wt. % YP50 carbon, 6 wt. % carbon black, and 50 wt. % TPU filtered using a 200 US mesh, and (3) 44 wt. % YP50 carbon, 6 wt. % carbon black, and 50 wt. % TPU filtered using a 300 US mesh. An image of the resulting sheet from sample 2 is provided in FIG. 8B, and images of the sheets from samples 1-3 are provided in FIGS. 8A and 8C. Sample 1 provided a sheet after 4 revolutions of the roll mill as the mixture stuck to the roll before extruding a sheet. Sample 2 provided a sheet after a single revolution, but the material stuck to the roll and the sheet had multiple holes present. Sample 3 provided a sheet after two revolutions of the roll mill as the mixture stuck to the roll before extruding a sheet.

### Example 6: Butane Working Capacity (BWC) Testing of Sorbent Material Sheets Using TPU and PTFE

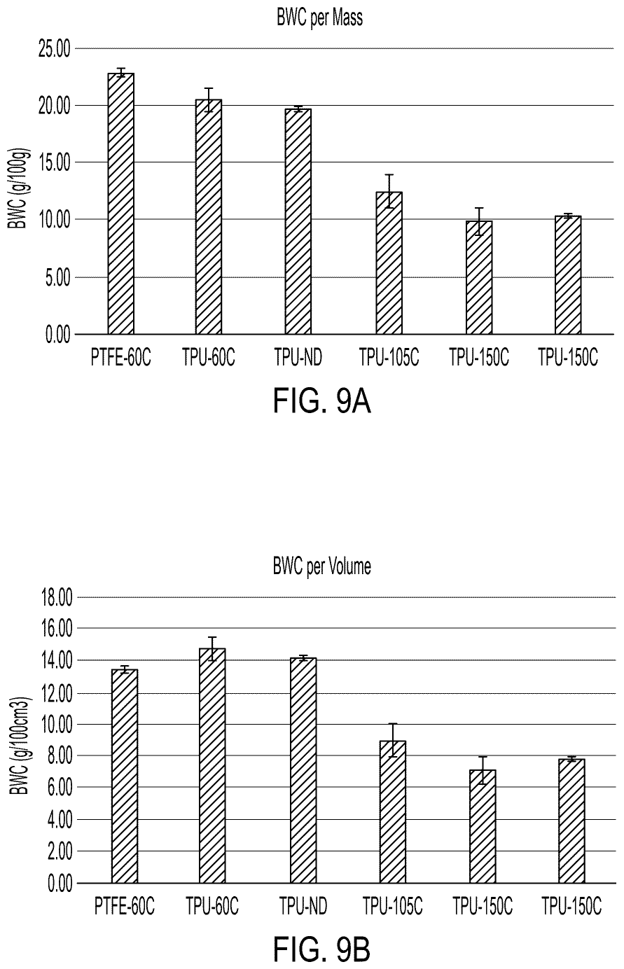

Testing was performed on the butane working capacity (BWC) of sorbent material sheets prepared using one of TPU and PTFE as a binder. Samples including TPU were prepared by mixing 50 wt. % of RB activated carbon from Calgon Carbon Corporation with 50 wt. % TPU, while samples including PTFE were prepared by mixing 80 wt. % of RB activated carbon from Calgon Carbon Corporation with 20 wt. % PTFE. Samples were prepared by rolling the mixtures through a roll mill with a surface temperature of about 77° C. at a rate of about 1.3-3.0 ft/min and drying each sample at various temperatures. Samples tested include: (1) a PTFE sample dried at 60° C., (2) a TPU sample dried at 60° C., (3) a TPU sample dried at 105° C., (4) a TPU sample with a thickness of 0.546 mm and dried at 150° C., (5) a TPU sample with a thickness of 0.358 mm and dried at 150° C., and (6) a TPU sample that was not dried. The BWC was tested as a BWC per mass and as a BWC per volume. Samples 2 and 6 performed similarly to sample 1 in BWC per mass and provided a slightly higher BWC per volume that sample 1. Furthermore, as the drying temperature increased, the BWC of the samples decreased. Graphical results of the testing are provided in FIGS. 9A and 9B.

### Example 7: Density and Tensile Strength Testing of Sorbent Material Sheets Using TPU and PTFE

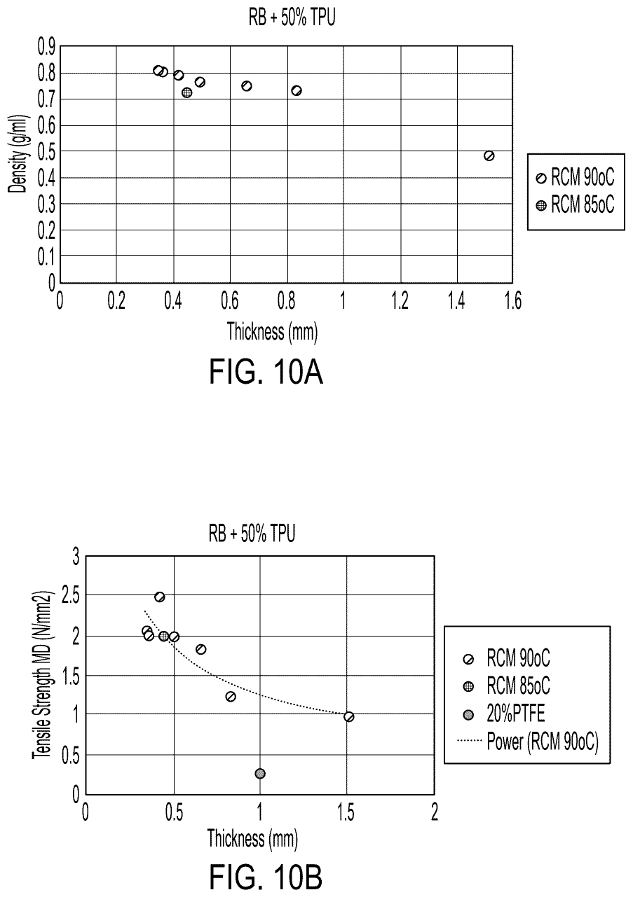

Testing was performed on the density and tensile strength of sorbent material sheets prepared using RB activated carbon from Calgon Carbon Corporation and one of TPU and PTFE as a binder. Samples including TPU were prepared by mixing 50 wt. % of RB activated carbon from Calgon Carbon Corporation with 50 wt. % TPU, while samples including PTFE were prepared by mixing 80 wt. % of RB activated carbon from Calgon Carbon Corporation with 20 wt. % PTFE. Samples were prepared by rolling the mixtures through a roll mill at 77° C., with one TPU sample rolled at a temperature of 70° C. The samples were rolled to various thicknesses and were tested for density by determining the weight and volume of a certain size of the sample. The samples were cut to a predetermined size and area. The weight of a sample was measured using a digital balance. The thickness of a sample was measured using a digital thickness gauge for textiles. The volume of a sample was calculated by multiplying the area of the sample by the thickness of the sample. The density of the sample was calculated by dividing the weight of the sample by the volume of the sample. The results of the density testing showed that as the sheet thickness increased, the density decreased. Graphical results of the density testing are provided in FIG. 10A. The tensile strength of the samples were tested by using a Mark-10 Tension and Compression Test Frame. The results of the tensile strength testing showed that as the sheet thickness increased, the tensile strength decreased. The test results also showed that the sheets prepared using TPU as a binder had a higher tensile strength than the sheet prepared using PTFE as a binder. Graphical results of the density testing in the machine direction are provided in FIG. 10B. Sample parameters and testing results are provided below in Table 1.

TABLE 1
TPU sorbent sheet testing results.

| | | | Tensile | Tensile |
|---|---|---|---|---|
| | | | strength | strength |
| | | Specific | (machine | (cross |
| Sample | Thickness | Density | direction, | direction, |
| Description | (mm) | (g/mL) | N/mm²) | N/mm²) |
| 50 wt. % RB and | 0.3447 | 0.8103 | 2.0558 | 2.0213 |
| 50 wt. % TPU | | | | |
| 50 wt. % RB and | 0.3583 | 0.8056 | 2.0003 | 2.6593 |
| 50 wt. % TPU | | | | |
| 50 wt. % RB and | 0.4189 | 0.7917 | 2.4808 | 2.2585 |
| 50 wt. % TPU | | | | |
| 50 wt. % RB and | 0.4491 | 0.7205 | 1.9840 | 1.8125 |
| 50 wt. % TPU | | | | |
| 50 wt. % RB and | 0.4957 | 0.7622 | 1.9788 | 1.6383 |
| 50 wt. % TPU | | | | |
| 50 wt. % RB and | 0.6598 | 0.7497 | 1.8311 | 2.1738 |
| 50 wt. % TPU | | | | |
| 50 wt. % RB and | 0.8336 | 0.7290 | 1.2163 | 0.998 |
| 50 wt. % TPU | | | | |
| 50 wt. % RB and | 1.5143 | 0.4843 | 0.9725 | 1.0870 |
| 50 wt. % TPU | | | | |
| 80 wt. % RB and | 1 | N/A | N/A | N/A |
| 20 wt. % PTFE | | | | |

### Example 8: Production of Sorbent Material Sheets Using SEPTON

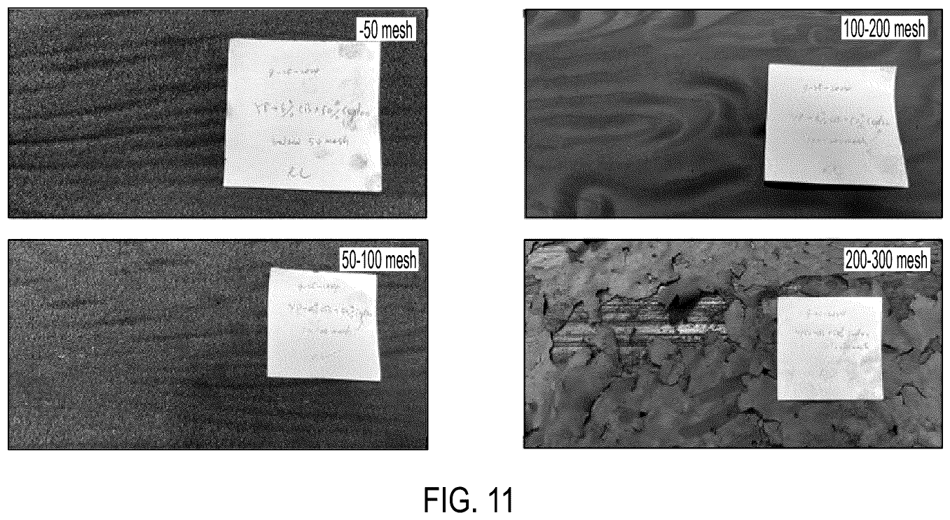

Sorbent material sheets were produced using YP50 activated carbon from Calgon Carbon Corporation, carbon black, and SEPTON with various particle sizes. SEPTON is a product provided by Kuraray Co., LTD that includes thermoplastic elastomers. Each of the sheets was made by blending a mixture of the carbon, the carbon black, and binder at room temperature and then rolling into a sheet using a roll mill with a surface temperature of about 77° C. at a rate of about 1.3 ft/min. The samples were prepared as follows: (1) 44 wt. % YP50 carbon, 6 wt. % carbon black, and 50 wt. % SEPTON filtered using a 50 US mesh, (2) 44 wt. % YP50 carbon, 6 wt. % carbon black, and 50 wt. % SEPTON filtered using a 50 US mesh and a 100 US mesh, (3) 44 wt. % YP50 carbon, 6 wt. % carbon black, and 50 wt. % SEPTON filtered using a 100 US mesh and a 200 US mesh, and (4) 44 wt. % YP50 carbon, 6 wt. % carbon black, and 50 wt. % SEPTON filtered using a 200 US mesh and a 300 US mesh. Images of the sheets are provided in FIG. 11. Each of samples 1-3 provided a complete sorbent material sheet, while sample 4 did not provide a complete sheet at the operating temperature of the roller.

### Example 9: Density and Tensile Strength Testing of Sorbent Material Sheets Using TPU and SEPTON

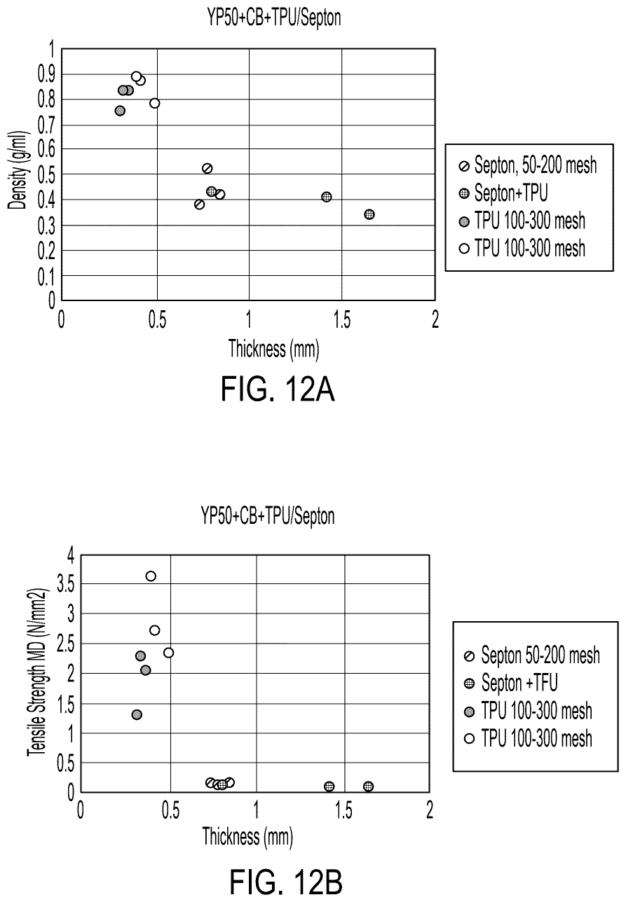

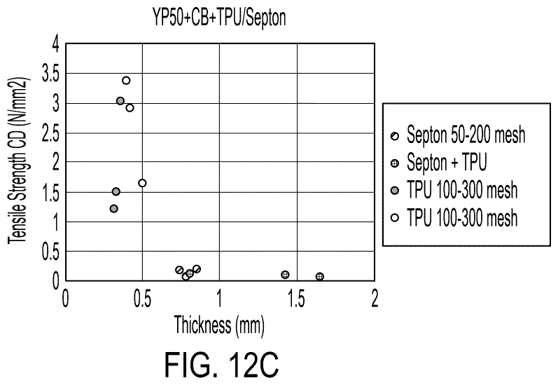

Testing was performed on the density and tensile strength of sorbent material sheets prepared using YP50 activated carbon from Calgon Carbon Corporation, carbon black, and TPU, SEPTON, and a combination of TPU and SETPON as a binder. Each of the sheets was made by blending a mixture of the carbon, the carbon black, and binder at room temperature and then rolling into a sheet using a roll mill with a surface temperature of about 77° C. at a rate of about 1.3 ft/min. The samples were prepared as follows: (1) 44 wt. % YP50 carbon, 6 wt. % carbon black, and 50 wt. % SEPTON filtered using a 50 US mesh, a 100 US mesh, and a 200 US mesh, (2) 41-44 wt. % YP50 carbon, 6 wt. % carbon black, 40-48 wt. % SEPTON filtered using a 50 US mesh and a 100 US mesh, and 5-10 wt. % TPU filtered using a 200 US mesh, (3) 44 wt. % YP50 carbon, 6 wt. % carbon black, and 50 wt. % TPU filtered using a 100 US mesh and a 300 US mesh, and (4) 44 wt. % YP50 carbon, 6 wt. % carbon black, and 50 wt. % TPU filtered using a 100 US mesh, a 200 US mesh, and a 300 US mesh. The samples were rolled to various thicknesses and were tested for density by determining the weight and volume of a certain size of the sample. The samples were cut to a predetermined size and area. The weight of a sample was measured using a digital balance. The thickness of a sample was measured using a digital thickness gauge for textiles. The volume of a sample was calculated by multiplying the area of the sample by the thickness of the sample. The density of the sample was calculated by dividing the weight of the sample by the volume of the sample. The results of the density testing showed that as the sheet thickness increased, the density decreased. Graphical results of the density testing are provided in FIG. 12A. The tensile strength of the samples in the machine direction and in the cross direction were tested by using a Mark-10 Tension and Compression Test Frame. The results of the tensile strength testing showed that as the sheet the samples having TPU as a binder had a higher tensile strength than the samples having SEPTON as a binder. Graphical results of the tensile strength testing are provided in FIGS. 12B and 12C. Sample parameters and testing results are provided below in Table 2.

TABLE 2
Septon and TPU sorbent sheet testing results.

| | | | Tensile | Tensile |
|---|---|---|---|---|
| | | | strength | strength |
| | | Specific | (machine | (cross |
| | Thickness | Density | direction, | direction, |
| Sample Description | (mm) | (g/mL) | N/mm²) | N/mm²) |
| Sample 1, 50 US Mesh | 0.734 | 0.385 | 0.15 | 0.20 |
| Sample 1, 100 US Mesh | 0.771 | 0.526 | 0.12 | 0.08 |
| Sample 1, 200 US Mesh | 0.845 | 0.421 | 0.15 | 0.20 |
| Sample 2, 40 wt. % | 0.802 | 0.434 | 0.11 | 0.13 |
| Septon, 10 wt. % TPU | | | | |
| Sample 2, 45 wt. % | 1.645 | 0.346 | 0.09 | 0.08 |
| Septon, 5 wt. % TPU | | | | |
| Sample 2, 48 wt. % | 1.419 | 0.411 | 0.10 | 0.12 |
| Septon, 5 wt. % TPU | | | | |
| Sample 3, 20 wt. % | 0.357 | 0.836 | 2.05 | 3.03 |
| 100 US mesh, 80 wt. | | | | |
| % 300 US mesh | | | | |
| Sample 3, 20 wt. % | 0.310 | 0.756 | 1.31 | 1.22 |
| 100 US mesh, 80 wt. | | | | |
| % 300 US mesh | | | | |
| Sample 3, 10 wt. % | 0.325 | 0.836 | 2.31 | 1.51 |
| 100 US mesh, 90 wt. | | | | |
| % 300 US mesh | | | | |
| Sample 4, 60 wt. % | 0.420 | 0.877 | 2.75 | 2.93 |
| 100 US mesh, 20 wt. | | | | |
| % 200 US mesh, 20 | | | | |
| wt.% 300 US mesh | | | | |
| Sample 4, 20 wt. % | 0.395 | 0.895 | 3.66 | 3.38 |
| 100 US mesh, 60 wt. | | | | |
| % 200 US mesh,20 | | | | |
| wt. % 300 US mesh | | | | |
| Sample 4, 10 wt. % | 0.494 | 0.786 | 2.36 | 1.66 |
| 100 US mesh, 10 wt. | | | | |
| % 200 US mesh, 80 | | | | |
| wt. % 300 US mesh | | | | |

### Example 10: Production of Sorbent Material Sheets Using Microfibrillated Cellulose

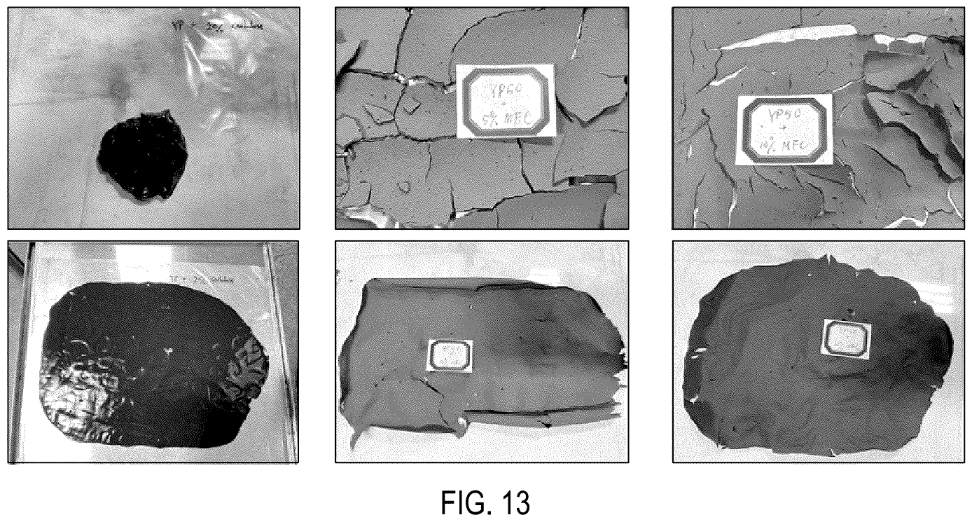

Sorbent material sheets were produced using YP50 activated carbon from Calgon Carbon Corporation and microfibrillated cellulose at various loadings. Each of the sheets was made by blending a mixture of the carbon and binder at room temperature and then rolling into a sheet using a hand rolling pin at room temperature. The samples were prepared as follows (1) 95 wt. % activated carbon and 5 wt. % wet microfibrillated cellulose, (2) 90 wt. % activated carbon and 10 wt. % wet microfibrillated cellulose, (3) 85 wt. % activated carbon and 15 wt. % wet microfibrillated cellulose, and (4) 80 wt. % activated carbon and 20 wt. % wet microfibrillated cellulose. The wet microfibrillated cellulose contains 2 wt. % microfibrillated cellulose and 98 wt. % water. Images of the samples are provided in FIG. 13. Each of samples 3 and 4 provided a complete sorbent material sheet, while samples 1 and 2 did not provide a complete sheet at the operating temperature of the roller.

### Example 11: Production of Sorbent Material Sheets Using PCL and PTFE

Sorbent material sheets were produced using RB activated carbon from Calgon Carbon Corporation and PCL and PTFE at various loadings. Each of the sheets was made by blending a mixture of the carbon and binder at room temperature and then rolling into a sheet using a roll mill with a surface temperature of about 65° C. at a rate of about 1.3 ft/min. The samples were prepared as follows (1) 40 wt. % activated carbon and 60 wt. % PCL, (2) 50 wt. % activated carbon and 50 wt. % PCL, (3) 60 wt. % activated carbon and 40 wt. % PCL, (4) 59 wt. % activated carbon, 40 wt. % PCL, and 1 wt. % PTFE, (5) 69 wt. % activated carbon, 30 wt. % PCL, and 1 wt. % PTFE, (6) 69.5 wt. % activated carbon, 30 wt. % PCL, and 0.5 wt. % PTFE, (7) 79.5 wt. % activated carbon, 20 wt. % PCL, and 0.5 wt. % PTFE, (8) 78 wt. % activated carbon, 20 wt. % PCL, and 2 wt. % PTFE, (9) 88 wt. % activated carbon, 10 wt. % PCL, and 2 wt. % PTFE, (10) 30 wt. % activated carbon and 70 wt. % PCL, and (11) 98 wt. % activated carbon and 2 wt. % PTFE. Samples 3, 7, and 11 were not able to provide sheets at the operating temperature of the roller. Sample 10 stuck to the rolls and was not able to produce sheets continuously, but small pieces of sheet samples were collected for analysis. Sample 9 provided a sheet of poor quality, and samples 1, 2, 5, and 8 provided a good quality sheet.

Samples 1, 2, 5, 8, and 10 were rolled to various thicknesses and were tested for density by determining the weight and volume of a certain size of the sample. The samples were cut to a predetermined size and area. The weight of a sample was measured using a digital balance. The thickness of a sample was measured using a digital thickness gauge for textiles. The volume of a sample was calculated by multiplying the area of the sample by the thickness of the sample. The density of the sample was calculated by dividing the weight of the sample by the volume of the sample. Additional samples were prepared and were dried in an oven. Rolled samples prepared as described above and were dried at a temperature of 105° C. overnight. Thickness and density measurements were performed on the dried samples as described above. Results of the density measurements are provided in below in Table 3.

TABLE 3
PCL and PTFE sorbent sheet testing results.

| | | | Specific |
|---|---|---|---|
| | | Thickness | Density |
| Sample | Condition | (mm) | (g/mL) |
| 1 | Not dried | 0.287 | 1.027 |
| 1 | Dried | 0.332 | 0.870 |
| 2 | Not dried | 0.312 | 0.803 |
| 2 | Dried | N/A | N/A |
| 5 | Not dried | 0.540 | 0.679 |
| 5 | Dried | 0.529 | 0.673 |
| 8 | Not dried | 0.656 | 0.631 |
| 8 | Dried | 0.654 | 0.613 |
| 10 | Not dried | 0.257 | 1.115 |
| 10 | Dried | 0.306 | 0.931 |

### Example 12: Production of Sorbent Material Sheets Using PCL, LDPE, and PTFE

Sorbent material sheets were produced using RB activated carbon from Calgon Carbon Corporation and PCL, LDPE and PTFE at various loadings. Each of the sheets was made by blending a mixture of the carbon and binder at room temperature and then rolling into a sheet using a roll mill with a surface temperature of about 65° C. or about 93° C. at a rate of about 1.3 ft/min. The samples were prepared as follows (1) 50 wt. % activated carbon, 10 wt. % LDPE, and 40 wt. % PCL rolled at 65° C., (2) 69 wt. % activated carbon, 30 wt. % LDPE, and 1 wt. % PTFE rolled at 65° C., (3) 78 wt. % activated carbon, 20 wt. % LDPE, and 2 wt. % PTFE rolled at 65° C., (4) 50 wt. % activated carbon and 50 wt. % LDPE rolled at 93° C., (5) 50 wt. % activated carbon, 45 wt. % LDPE, and 5 wt. % PCL rolled at 93° C., (6) 50 wt. % activated carbon, 40 wt. % LDPE, and 10 wt. % PCL rolled at 93° C., (7) 50 wt. % activated carbon, 35 wt. % LDPE, and 15 wt. % PCL rolled at 93° C., (8) 50 wt. % activated carbon, 30 wt. % LDPE, and 20 wt. % PCL rolled at 93° C., (9) 50 wt. % activated carbon, 25 wt. % LDPE, and 25 wt. % PCL rolled at 93° C., (10) 50 wt. % activated carbon, 20 wt. % LDPE, and 30 wt. % PCL rolled at 93° C., (11) 50 wt. % activated carbon, 15 wt. % LDPE, and 35 wt. % PCL rolled at 93° C., (12) 50 wt. % activated carbon, 10 wt. % LDPE, and 40 wt. % PCL rolled at 93° C., (13) 50 wt. % activated carbon, 5 wt. % LDPE, and 45 wt. % PCL rolled at 93° C., and (14), 50 wt. % activated carbon and 50 wt. % PCL rolled at 93° C. Samples 4-11 were not able to provide sheets at the operating temperature of the roller. Samples 12-14 provided a sheet of poor quality at the operating temperature, and samples 1-3 provided a good quality sheet at the operating temperature.

### Example 13: Production of Sorbent Material Sheets Using PA6, TPU, and PCL

Sorbent material sheets were produced using RB activated carbon from Calgon Carbon Corporation and PCL, TPU, and PA6 at various loadings. Each of the sheets was made by blending a mixture of the carbon and binder at room temperature and then rolling into a sheet using a roll mill with a surface temperature of about 87° C. at a rate of about 1.3 ft/min. The samples were prepared as follows (1) 50 wt. % activated carbon and 50 wt. % PA6, (2) 50 wt. % activated carbon and 50 wt. % TPU, (3) 60 wt. % activated carbon and 40 wt. % TPU, (4) 50 wt. % activated carbon and 50 wt. % PCL, (5) 50 wt. % activated carbon, 40 wt. % PCL, and 10 wt. % TPU, (6) 50 wt. % activated carbon, 30 wt. % PCL, and 20 wt. % TPU, (7) 50 wt. % activated carbon, 20 wt. % PCL, and 30 wt. % TPU, (8) 50 wt. % activated carbon, 10 wt. % PCL, and 40 wt. % TPU, (9) 40 wt. % activated carbon and 60 wt. % TPU. Samples 1 and 3 were not sheetable at the operating temperatures and samples 2 and 6-8 were able to produce sheets. Samples 4 and 9 provided sheets, however, the sheets were brittle and had a low strength.

Samples 2 and 6-7 were rolled to various thicknesses and were tested for density by determining the weight and volume of a certain size of the sample. The samples were cut to a predetermined size and area. The weight of a sample was measured using a digital balance. The thickness of a sample was measured using a digital thickness gauge for textiles. The volume of a sample was calculated by multiplying the area of the sample by the thickness of the sample. The density of the sample was calculated by dividing the weight of the sample by the volume of the sample. The tensile strength of samples 2, 6, 7, and 8 were tested by using a Mark-10 Force Test Frame. Results of the tensile strength testing and the density measurements are provided below in Table 4.

TABLE 4
PA6, TPU, and PCL sorbent sheet testing results.

| | | | Tensile | Tensile |
|---|---|---|---|---|
| | | | strength | strength |
| | | Specific | (machine | (cross |
| Sample | Thickness | Density | direction, | direction, |
| Description | (mm) | (g/mL) | N/mm²) | N/mm²) |
| 2 | 0.546 | 0.756 | 1.50 | 1.23 |
| 6 | 0.428 | 0.788 | 0.61 | 0.31 |
| 7 | 0.416 | 0.760 | 0.88 | 0.54 |
| 8 | 0.429 | 0.743 | 1.17 | 0.85 |

### Example 14: Differential Scanning Calorimetry (DSC) Testing of Binders

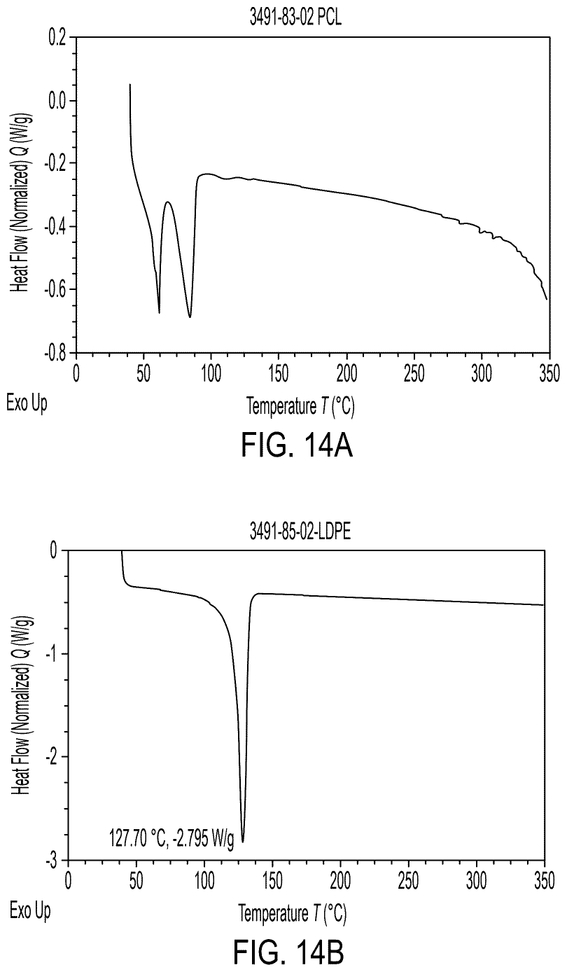

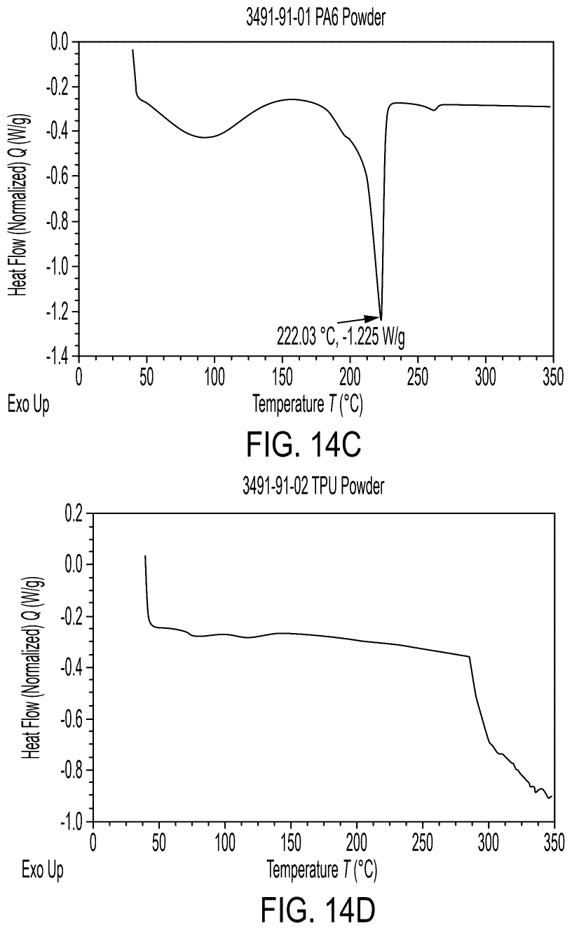

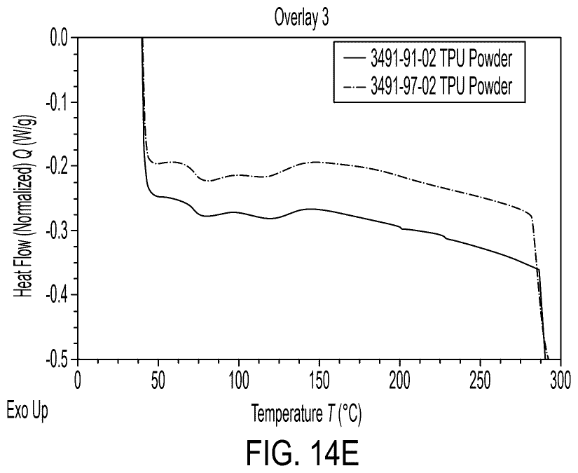

Differential scanning calorimetry (DSC) testing was performed on potential binders for use in sorbent material sheets. The DSC testing was performed to determine the various transition points of the materials used as binders. Testing was performed on powders of PCL, LDPE, PA6, and two samples of TPU. DSC testing was performed from a temperature of 40° C. to 350° C. Results of the DSC testing for PCL, LDPE, and PA6 are provided in FIGS. 14A-14C, and results of the DSC testing for the TPU samples are provided in FIGS. 14D-14E.

### Example 15: Production of Sorbent Material Sheets Using Carbon Black, TPU, SEPTON, and PVOH

Sorbent material sheets were produced using various binders. The sorbent material sheets were produced using YP50 activated carbon from Calgon Carbon Corporation, carbon black, and combinations of TPU, PVOH, and SEPTON as a binder. Two types of PVOH were used as binders, with the first PVOH being EXCEVAL™ from Kuraray Co., LTD (PVOH-1) and the second being POVAL™ from Kuraray Co., LTD (PVOH-2). Each of the sheets was made by blending a mixture of the carbon and binder at room temperature and then rolling into a sheet using a roll mill with a surface temperature of about 87° C. at a rate of about 1.3 ft/min. The samples were prepared as follows: (1) 47 wt. % YP50, 3 wt. % carbon black, and 50 wt. % PVOH-1, (2) 9 wt. % YP50, 1 wt. % carbon black, and 90 wt. % PVOH-1, (3) 19 wt. % YP50, 1 wt. % carbon black, and 80 wt. % PVOH-1, (4) 28 wt. % YP50, 2 wt. % carbon black, and 70 wt. % PVOH-2, (5) 19 wt. % YP50, 1 wt. % carbon black, and 80 wt. % PVOH-2, (6) 28 wt. % YP50, 2 wt. % carbon black, and 70 wt. % PVOH-2, (7) 37 wt. % YP50, 3 wt. % carbon black, and 60 wt. % PVOH-2, (8) 35 wt. % YP50, 2 wt. % carbon black, and 63 wt. % SEPTON, (9) 26 wt. % YP50, 2 wt. % carbon black, and 72 wt. % SEPTON, (10) 35 wt. % YP50, 3 wt. % carbon black, and 62 wt. % SEPTON, (11) 29 wt. % YP50, 2 wt. % carbon black, 6 wt. % PVOH-2, and 63 wt. % SEPTON, (12) 33 wt. % YP50 and 67 wt. % SEPTON, (13) 46 wt. % YP50, 3 wt. % carbon black, and 51 wt. % SEPTON, (14) 59 wt. % YP50, 4 wt. % carbon black, and 37 wt. % SEPTON, (15) 39 wt. % YP50, 3 wt. % carbon black, 7 wt. % PVOH-2, and 51 wt. % SEPTON, and (16) 39 wt. % YP50, 3 wt. % carbon black, 7 wt. % TPU, and 51 wt. % SEPTON. Sample parameters are provided below in Table 5.

TABLE 5

| | | Carbon | | | | Septon |
|---|---|---|---|---|---|---|
| | YP50 | Black | TPU | PVOH-1 | PVOH-2 | Emulsion |
| Sample | (g) | (g) | (g) | (g) | (g) | (g) |
| 1 | 86 | 6 | 0 | 93 | 0 | 0 |
| 2 | 43 | 3 | 0 | 414 | 0 | 0 |
| 3 | 43 | 3 | 0 | 184 | 0 | 0 |
| 4 | 43 | 3 | 0 | 107 | 0 | 0 |
| 5 | 43 | 3 | 0 | 0 | 184 | 0 |
| 6 | 43 | 3 | 0 | 0 | 107 | 0 |
| 7 | 86 | 6 | 0 | 0 | 138 | 0 |
| 8 | 43 | 3 | 0 | 0 | 0 | 78 |
| 9 | 86 | 6 | 0 | 0 | 0 | 238 |
| 10 | 133 | 10 | 0 | 0 | 0 | 238 |
| 11 | 86 | 6 | 0 | 0 | 18 | 185 |
| 12 | 50 | 0 | 0 | 0 | 0 | 103 |
| 13 | 86 | 6 | 0 | 0 | 0 | 95 |
| 14 | 86 | 6 | 0 | 0 | 0 | 55 |
| 15 | 86 | 6 | 0 | 0 | 15 | 111 |
| 16 | 86 | 6 | 15 | 0 | 0 | 111 |

Results of the sorbent material sheet production showed that samples 2, 3, 5, and 6 formed sheets that were slightly brittle. Samples 1, 4, 11, and 14 were not able to form sheets after rolling. Sample 7 formed a dusty, brittle sheet. Sample 8 stuck to the roller for 4 revolutions before successfully forming a sheet that was manually removed from the roller. Sample 9 was too wet to process the mixture in the blender. Sample 10 was processed in the blender but was not able to roll to make a sheet. Sample 12 was too sticky to hand roll a sheet. Samples 13 and 15 successfully formed sheets with some voids. Sample 16 formed a slightly sticky sheet. The results of these tests show the importance of binder selection and binder amounts in the sorbent material sheets.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A sorbent material sheet product comprising:
a sorbent material; and
a binder comprising one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), ethylene vinyl alcohol (EVOH), polyvinylidene chloride (PVDC), and ethylene vinyl acetate (EVA).

2. The sorbent material sheet product of claim 1, wherein the binder has a particle size of about 1 μm to about 1000 μm.

3. The sorbent material sheet product of claim 1, wherein the binder has a particle size of about 100 μm to about 800 μm.

4. The sorbent material sheet product of claim 1, wherein the binder has a particle size of about 500 μm to about 700 μm.

5. The sorbent material sheet product of claim 1, wherein the sorbent material sheet product has a tensile strength of about 1 N/mm² to about 100 N/mm².

6. The sorbent material sheet product of claim 1, wherein the sorbent material sheet product has a thickness of about 100 μm to about 5,000 μm.

7. The sorbent material sheet product of claim 1, wherein the binder is present in the sorbent material sheet product in an amount of about 1 wt. % to about 90 wt. %.

8. The sorbent material sheet product of claim 1, wherein the binder is present in the sorbent material sheet product in an amount of about 50 wt. %.

9. The sorbent material sheet product of claim 1 further comprising one or more of carbon black, graphite, carbon nanotubes, copper powder, an ion exchange resin, a polyelectrolyte, and an inorganic nanoparticle.

10. The sorbent material sheet product of claim 1, wherein the sorbent material comprises activated carbon, reactivated carbon, carbon nanotubes, graphenes, natural and synthetic zeolite, silica, silica gel, alumina, zirconia, clay, polymer resins, metal-organic framework (MOF)-based materials, and diatomaceous earths, and combinations thereof.

11. A method of manufacturing a sorbent material sheet, the method comprising:
providing a sorbent material and a binder comprising one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), ethylene vinyl alcohol (EVOH), polyvinylidene chloride (PVDC), and ethylene vinyl acetate (EVA);
mixing the sorbent material and the binder to form a mixture; and
forming the mixture into a sorbent material sheet.

12. The method of claim 11, wherein the sorbent material sheet is formed by one of molding, slurry coating, extrusion, or rolling.

13. The method of claim 11, wherein the binder has a particle size of about 100 μm to about 5,000 μm.

14. The method of claim 11, wherein the binder has a particle size of about 100 μm to about 800 μm.

15. The method of claim 11, wherein the binder has a particle size of about 500 μm to about 700 μm.

16. The method of claim 11, wherein the sorbent material sheet has a tensile strength of about 1 N/mm² to about 100 N/mm².

17. The method of claim 11, wherein the sorbent material sheet is rolled to a thickness of about 100 μm to about 5,000 μm.

18. The method of claim 11, wherein the binder is present in the sorbent material sheet in an amount of about 1 wt. % to about 90 wt. %.

19. The method of claim 11, wherein the binder is present in the sorbent material sheet in an amount of about 50 wt. %.

20. The method of claim 11, wherein the mixture is formed at a temperature of about 25° C. to about 250° C.

21. The method of claim 11, wherein the mixture is formed by rolling using a roll mill, wherein the roll mill is rolled at a rate of about 0.1 ft./min to about 20 ft./min.

22. The method of claim 11, further comprising:
providing an additive; and
adding the additive to the mixture,
wherein the additive comprises one or more of carbon black, graphite, carbon nanotubes, copper powder, an ion exchange resin, a polyelectrolyte, clay, carbon nanotubes, graphene, metal-organic framework (MOF)-based materials, and an inorganic nanoparticle.

23. A method of removing a target compound from a fluid, the method comprising:
providing a sorbent material sheet product including a sorbent material and a binder comprising one or more of polyvinylidene fluoride (PVDF), polyvinyl butyral (PVB), polyvinyl chloride (PVC), low density polyethylene (LDPE), polycaprolactone (PCL), polyamide 6 (PA6), thermoplastic polyurethane (TPU), a microfibrillated cellulose, a styrenic thermoplastic elastomer, polypropylene, polyvinyl alcohol (PVOH), ethylene vinyl alcohol (EVOH), polyvinylidene chloride (PVDC), and ethylene vinyl acetate (EVA); and
contacting the fluid with the sorbent material sheet product.
